(19) United States
(12) Patent Application Publication
(10) Pub. No.: US 2018/0095985 A1
(43) Pub. Date: Apr. 5, 2018

(54) Physical Location Scrambler for Hashed Data De-Duplicating Content-Addressable Redundant Data Storage Clusters

(71) Applicant: Cubistolabs, Inc., Fremont, CA (US)

(72) Inventor: Silei Zhang, Fremont, CA (US)

(21) Appl. No.: 15/706,645

(22) Filed: Sep. 15, 2017

Related U.S. Application Data
(60) Provisional application No. 62/402,977, filed on Sep. 30, 2016.

(51) Int. Cl. G06F 17/30

(52) U.S. Cl. CPC G06F 17/30156; G06F 17/30194; G06F 17/30097; G06F 17/30212

(57) ABSTRACT

Data de-duplication uses a hash of a scrambled data block as an address where the data block is stored to. The data storage system has multiple replication nodes, each storing only one copy of the data. Each replication node is assigned a unique identifier that is a seed to initialize a data scrambler. Each replication node scrambles the data to a different scrambled data value, since each node has a different unique identifier. Each node's scrambled data is cryptographically hashed to generate a different hash for each replication node. The hash is the address that the scrambled data is stored to in that replication node. Each replication node stores a different scramble of the data, and stores it to a different physical location due to the different hash. Thus the data is stored to diverse physical locations on different replication nodes, reducing systematic errors. All hashes are stored as metadata.

### RELATED APPLICATION

This application claims priority to the co-pending provisional application for “Location Randomizer for Robust Data Storage Clusters”, U.S. Ser. No. 62/402,977, filed Sep. 30, 2016, hereby incorporated by reference.

### FIELD OF THE INVENTION

This invention relates to data storage systems, and more particularly to data de-duplication with randomized locations of redundant copies.

### BACKGROUND OF THE INVENTION

Large data processing centers often replicate data over multiple storage nodes and devices to provide redundant copies in case of various system failures. More recently, data replication is also being provided in smaller systems to provide more robust data. Even personal computers and home networks may replicate data across several nodes or drives to provide better data protection and availability.

FIGS. 1A, 1B show data replication across several homogenous nodes. In FIG. 1A, memory 12, 13, 14 can each be one or more disk drives, solid state, storage class memory (SCM), volatile memory, or other kinds of storage devices. A key such as a file name, path, pointer, address, keyword, or other identifier of the data is provided to the storage system and is looked up in metadata storage 10. Metadata includes various kinds of information about the data being stored, such as file permissions, timestamps or dates or creation, updates, etc., identifiers of users of the data, persistence information, caching information, etc., as well as address mapping information. In particular, metadata storage 10 includes an address map that maps the key or input system address to a Logical Block Address (LBA). The LBA is applied to each of memory 12, 13, 14 as an address, causing the write data to be written into each of memory 12, 13, 14 at the address location indicated by the LBA. In this example, three copies or duplicates of the data are stored in the 3 nodes of memory 12, 13, 14. Should memory 12 fail, the data can be read from either memory 13 or from memory 14.

The hardware and software in a data storage cluster are often homogenous, so that memory 12, 13, 14 have the same size, use the same physical media, are manufactured by the same vendor, and run the same internal firmware. When the same address (LBA) is applied to all three of memory 12, 13, 14, the data is likely to be stored in the same physical location within each node. For example, when memory 12, 13, 14 each have four physical disk drive bays, it is likely that the replicated user data is stored in the same disk drive bay and at the same offset within that drive bay in each of the replication nodes of memory 12, 13, 14.

In FIG. 1B, a software bug occurs, such as in the system software or firmware. For example, the storage system firmware may miscalculate the total storage capacity. The system assigns too many blocks of data to each of memory 12, 13, 14.

In this example, the system eventually assigns a data write to the missing blocks of data. The system software creates an entry in metadata storage 10 that has too large of an assigned LBA associated with a key in metadata storage 10. The LBA has an offset that is larger than the size of memory 12, 13, 14. The LBA points to missing blocks 16, 17, 18 that are not physically present in memory 12, 13, 14. The user data is written to missing blocks 16, 17, 18 and is lost since no physical memory exists for this LBA. Even though the data is replicated across three nodes, all copies of the data are lost since the software bug causes the wrong LBA to be generated for all three nodes.

This software bug could also occur within the firmware of each node, such as the firmware running on the physical devices of memory 12, 13, 14. A system design defect could create similar conditions in one of the bays in each of memory 12, 13, 14, such as design defects that cause overheating or power supply problems. Global power outages or un-even wear of storage devices caused by non-uniform workload distribution could also cause simultaneous data corruption of several or all data replicas across several devices.

The same bug in firmware could cause the same error to occur in all replication nodes, resulting in the loss of all redundant copies of the data. Thus homogenous storage nodes are undesirable.

Data centers sometimes use heterogeneous replication nodes to reduce the risk of simultaneous data failures. FIG. 2 shows data replication in a heterogeneous data storage system. Storage appliances or devices from several different storage vendors are used for memory 22, 23, 24. Memory 22 is a storage node with disk drives by Western Digital, while memory 23 is a node using disk drives by Seagate. Memory 23 uses HP drives. The storage vendors may map storage locations differently for each storage appliance, and different firmware may be used both by the storage appliance and by the underlying disk drives within that storage appliance.

In the example of FIG. 1B, where system software miscalculates the total storage capacity and generates an entry in metadata storage 10 with an LBA that is too large, the LBA may be internally mapped to different physical locations in each of the different storage nodes. For example, the LBA may still map to missing block 16 in memory 12, causing the write data to be lost in node_0. However, memory 23 may be larger and include physical memory for the LBA written to last block 17 of memory 23. Also, the firmware on node_2 may assign the LBA to an earlier physical block in memory 24 rather than to missing block 18. Thus while one data replica is lost in the first replication node, two other data replicas are safely stored in the last two replication nodes.

Using heterogeneous nodes with different storage vendors reduced the risk of complete data loss when a system defect occurs. However, the cost to build and maintain the heterogeneous storage system is higher, since upgrades and firmware updates need to come from three different vendors rather than from just one vendor. Manageability, maintenance, upgrades, data migration, and storage planning are much more complicated when three storage vendors are used than when just one storage vendor is used.

Data de-duplication is sometimes used in storage systems. A hash of the user data is generated for each data write. Then the hash is used as the address of the user data. Since the storage location or address is a function of the user data, all duplicate copies of the user data map to the same address, so the data is stored only once. Since the address is a function of the data itself, this is a content-addressable memory. When redundancy is added, the same data values generate the same hash values and are likely to be mapped to the same physical locations across replication nodes. The same (key, value) pairs usually are stored on the same relative drive bay and with the same offset across all replication nodes. Thus the same problems of FIG. 1B exist for a content-addressable memory when replication is added. Replicas of the user data are likely to be mapped to the same physical offsets within each node, since the user data hashes to the same address in each node.

What is desired is a data storage system that replicates data across homogenous nodes, while scrambling data and randomizing the physical locations used to store data replicas in each node. A data de-duplication system with data replication across homogenous nodes is desirable where the data stored in replicas in each node are scrambled, and the physical locations are randomized to reduce susceptibility to non-random system errors.

### BRIEF DESCRIPTION OF THE DRAWINGS

FIGS. 1A, 1B show data replication across several homogenous nodes.

FIG. 2 shows data replication in a heterogeneous data storage system.

FIG. 3 is a block diagram of a storage system that randomizes address locations.

FIG. 4 is a block diagram of a data de-duplication storage system with replication to scrambled locations.

FIG. 5 shows reading from a de-duplicated storage system with scrambled replication.

FIG. 6 is an embodiment of the data de-duplication storage system using a global scrambler and hash engine.

FIGS. 7A, 7B highlight error detection for a data de-duplication storage system with storage location randomization across replication nodes.

FIG. 8 shows pseudo-code that pre-scrambles data before hashing to perform data de-duplication with replication.

FIG. 9 is a flowchart of writing to replicated data nodes using hashes of uniquely scrambled data.

FIG. 10 is a flowchart of reading from replicated data nodes using hashes of uniquely scrambled data.

### DETAILED DESCRIPTION

The present invention relates to an improvement in data de-duplication storage redundancy. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

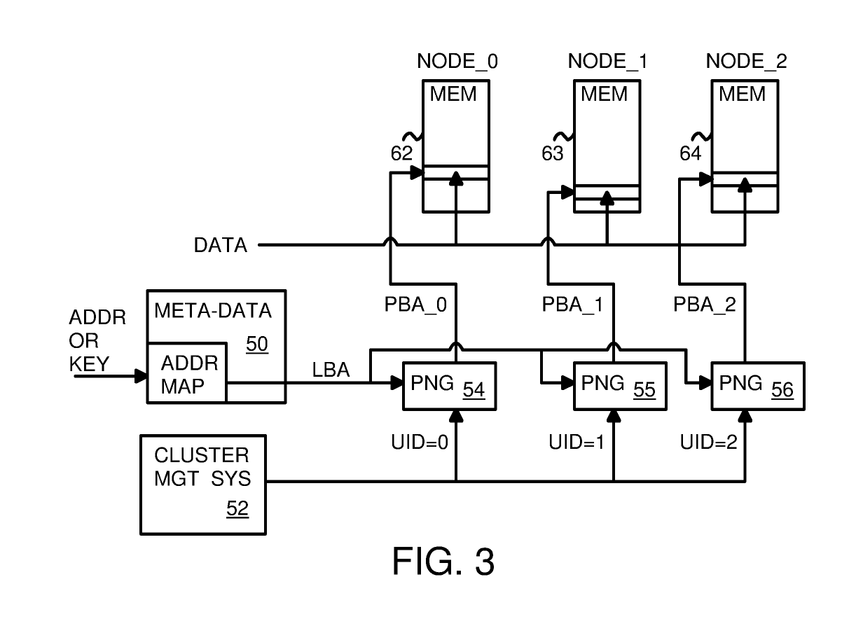

FIG. 3 is a block diagram of a storage system that randomizes address locations. When the system is initialized, or when a storage node or device is installed, cluster management system 52 assigns each storage node a unique identifier. The unique identifier distinguishes one replication storage node from another. In this example, cluster management system 52 assigns UID=0 to node_0 with memory 62, while UID=1 is assigned to replication node 1 with memory 63, and UID=2 is assigned to node_2 with memory 64.

The LBA generated by metadata storage 10 for a key or system address is not directly applied to memories 62, 63, 64. Instead, the LBA is input to each of pseudo-random-number generator (PNG) 54, 55, 56. Each PNG 54, 55, 56 also receives the unique identifier assigned by cluster management system 52. The UID input to PNG 54, 55, 56 acts as a seed for the random-number generation. Since each of PNG 54, 55, 56 receives a unique identifier with a different value, each PNG 54, 55, 56 is seeded with a different seed value. Thus PNG 54 generates a different sequence of random numbers than does PNG 55, and likewise PNG 56 generates a third sequence of random numbers.

The LBA input is modified by PNG 54, 55, 56 to generate three different physical-block addresses (PBA). For example, a sequence of random numbers may be selected by the UID seed, and then the LBA is used to select one of the random numbers in the sequence. Since the UID seeds are different and unique for each replication node, each of PNG 54, 55, 56 generates a different PBA for any given LBA. PNG 54 generates PBA_0 that is applied as the address input to memory 62 in node_0, while PNG 55 generates PBA_1 that is applied as the address input to memory 63 in node_1, and PNG 56 generates PBA_2 that is applied as the address input to memory 64 in node_2.

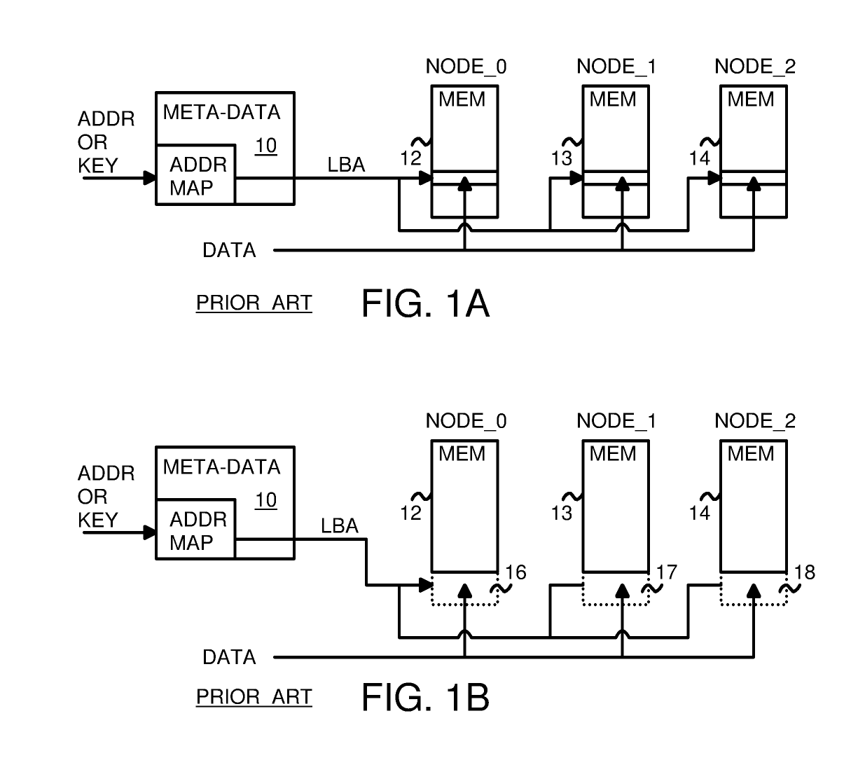

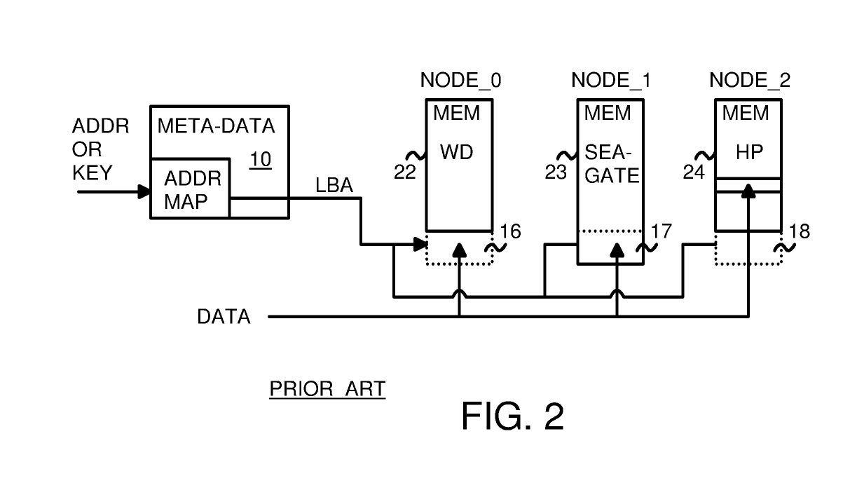

Thus the physical addresses to the replication nodes are randomized using the unique identifier assigned to each node by cluster management system 52. User data is stored to a different offset location in each of memories 62, 63, 64. This randomizing of addresses across replication nodes ensures that data is stored in different physical locations, such as different drive bays and offsets. A system failure such as shown in FIG. 1B would not destroy all data replicas, since the data replica storage locations are randomized.

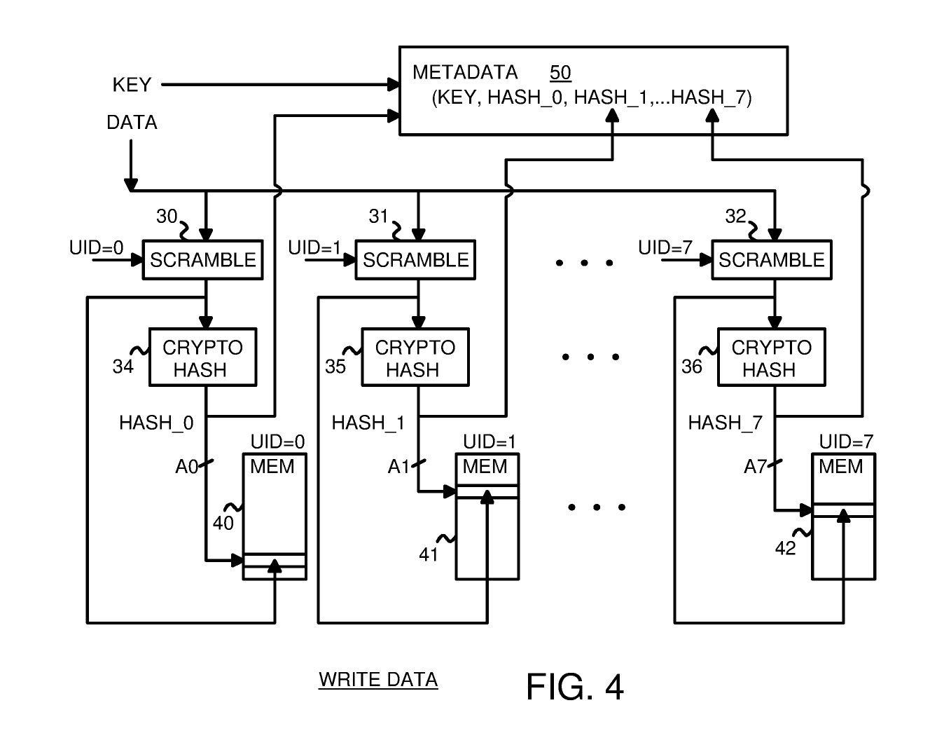

FIG. 4 is a block diagram of a data de-duplication storage system with replication to scrambled locations. Data block de-duplication has the advantage of storing a block of data only once. Many keys in metadata storage 50 can map to the same copy of the data block. Some data blocks, such as all zeros or all ones, may appear frequently, so de-duplication can reduce overall storage requirements.

While data replication may seem to be the opposite of data de-duplication, data replication is useful to improve robustness. If data de-duplication were to store only one copy of a frequently-used data block, and that one copy were somehow damaged or lost, the system could be impacted severely. Thus the data can be first de-duplicated, and then several replicas of the data stored to provide backup copies.

In this example, there are eight replication nodes node_0, node_1, . . . node_7, each assigned a different unique identifier UID=0, 1, 2, . . . 7 by cluster management system 52 (not shown, see FIG. 3). Each replication node has a memory 40, 41, . . . 42, each of which can be one or more disk drives, flash memories, dynamic-random-access memory (DRAM), storage class memory (SCM), or other mass storage.

The host system sends a key and user data to be stored and later retrieved using the key. The user data to be stored is sent to all replication nodes and input to scrambler 30, 31, . . . 32. Each of scrambler 30, 31, . . . 32 receives the unique identifier for that replication node as a seed input. Since each replication node is assigned a unique and different value of the unique identifier, each of scrambler 30, 31, . . . 32 outputs a different result in response to the same data being input to all scramblers 30, 31, . . . 32.

The scrambled data from scrambler 30, 31, . . . 32 is then applied to cryptohash engine 34, 35, . . . 36 that generate a cryptographic hash. Since each replication node generates a different scramble of the data, the inputs to each of cryptohash engine 34, 35, . . . 36 are different, so the hashes generated for each replication node are different.

The hashes generated by cryptohash engine 34, 35, . . . 36 are then applied as the address inputs to memory 40, 41, . . . 42. For example, the scrambled data from scrambler 30 is input to cryptohash engine 34 to generate hash_0, which is applied as the address into memory 40 of node_0. The scrambled data from scrambler 31 is input to cryptohash engine 35 to generate hash_1, which is applied as the address into memory 41 of node_1.

Although the data inputs to scrambler 30, 31 are the same, the seed input to scrambler 30, 31 are the unique identifiers that differ, causing the scrambled data from scrambler 30, 31 to differ. Since the hash values hash_0 and hash_1 differ, the physical locations that the data are stored in memory 40, 41 are not the same relative locations. Thus by scrambling the data before hashing at each replication node, the physical storage locations are randomized. This provides better robustness since data replicas are stored across different physical locations within each replication node.

The scrambled data generated by scrambler 30, 31, . . . 32 is applied as the write-data input to memory 40, 41, . . . 42. Thus not only are the physical locations scrambled, but the data itself is scrambled. This dual-scrambling further increases data storage robustness.

While unscrambled data could be stored in memory 40, 41, . . . 42, storing the scrambled data in memory 40, 41, . . . 42 provides added protection against data-pattern-sensitive errors. For example, some memory systems may be susceptible to errors that occur for specific data patterns, such as all zero, all ones, checkerboard, walking ones, etc. Flash memory systems may have a pattern sensitivity that may cause read/write disturbances and/or reduced data retention, or other problems. Indeed, such data patterns are often applied during manufacturing testing since these data patterns are more likely to fail. Since scrambler 30, 31, . . . 32 produce different data from the same user data input, each replication node generates and stores different scrambled data into memory 40, 41, . . . 42.

An entry is created in metadata storage 50 when data for a new key is written. The key can be a filename, pathname, or can be a keyword, or a system address such as a block address, or can be a pointer, or object name. The entries in metadata storage 50 are indexed by the key. Each entry in metadata storage 50 also stores all of the hashes for that data. For example, when data for a new key is written to memory 40, 41, . . . 42, the hashes generated by cryptohash engine 34, 35, . . . 36, hash_0, hash_1, . . . hash_7, are also stored with the new key as an entry in metadata storage 50. Since the hashes are addresses of memory 40, 41, . . . 42, the key, hashes entry in metadata storage 50 points to the physical locations in memory 40, 41, . . . 42 that the data is stored at.

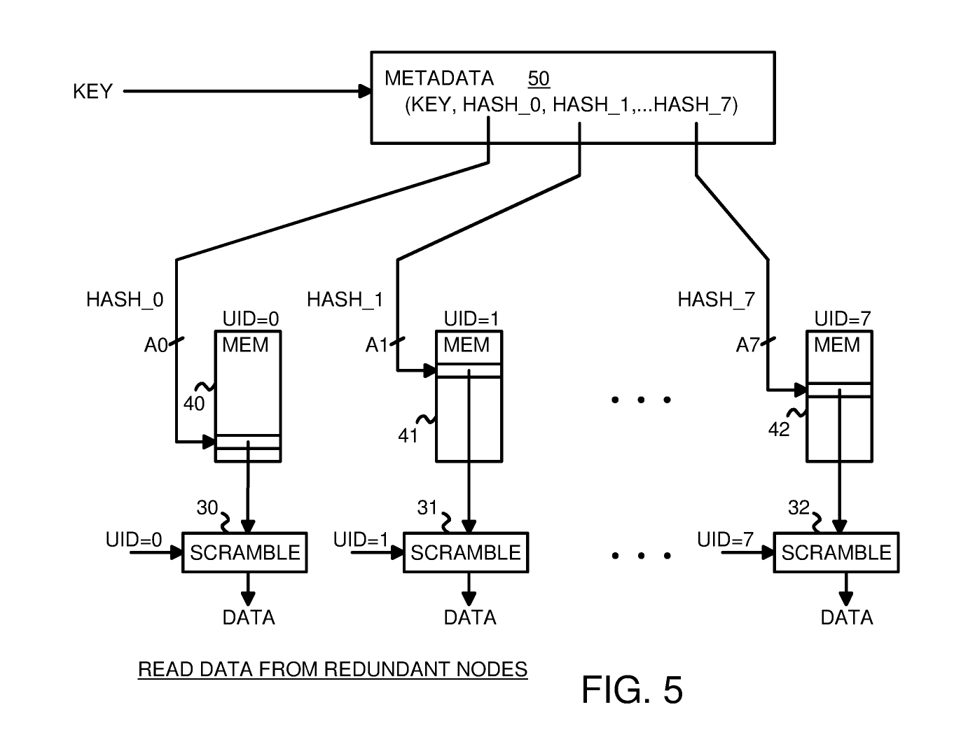

FIG. 5 shows reading from a de-duplicated storage system with scrambled replication. The system requests a read by sending the key to the storage system. The key is looked up in metadata storage 50. An entry for the key is read along with the hashes for that entry.

The hashes from the matching entry are applied as addresses into memory 40, 41, . . . 42. The scrambled data is then read out of memory 40, 41, . . . 42, and can be unscrambled, such as by using scrambler 30, 31, . . . 32 in unscrambling mode with the unique identifiers as seeds. Alternatively, if unscrambled data is stored in memory 40, 41, . . . 42, then unscrambling is not needed to recover the data.

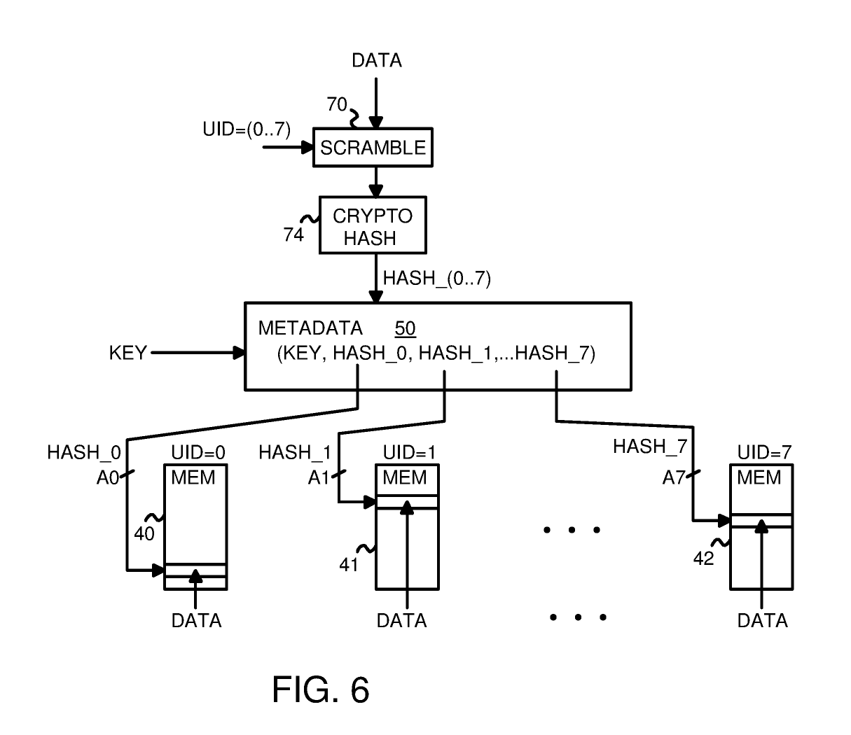

FIG. 6 is an embodiment of the data de-duplication storage system using a global scrambler and hash engine. Rather than have scrambler 30, 31, . . . 32 and cryptohash engine 34, 35, . . . 36 in each of the replication nodes, as shown in FIG. 4, the scrambling and hashing functions can be performed before the hashes are sent to the replication nodes.

Scrambler 70 and cryptohash engine 74 exist outside of the replication nodes, such as in the storage system's global control firmware or software. The user data to be written is input to scrambler 70, and each of the unique identifiers assigned to the replication nodes is successively applied as the seed to scrambler 70. The scrambled data flows from scrambler 70 to cryptohash engine 74 to generate all of the hashes (hash_0, hash_1, hash_2, . . . hash_7), one for each replication node.

The hashes generated by cryptohash engine 74 are written into the entry for the key in metadata storage 50, either before memory 40, 41, . . . 42 are written, or after. The entry may be marked as provisional until the operation successfully completes without errors.

The hashes generated by cryptohash engine 74 are sent to the replication nodes and used as the addresses of memory 40, 41, . . . 42. The data, either scrambled or unscrambled, is then written to these locations in memory 40, 41, . . . 42. Since the data input to cryptohash engine 74 is already scrambled, different hashes are produced, causing the data to be stored at different physical locations in each of memory 40, 41, . . . 42, improving data robustness.

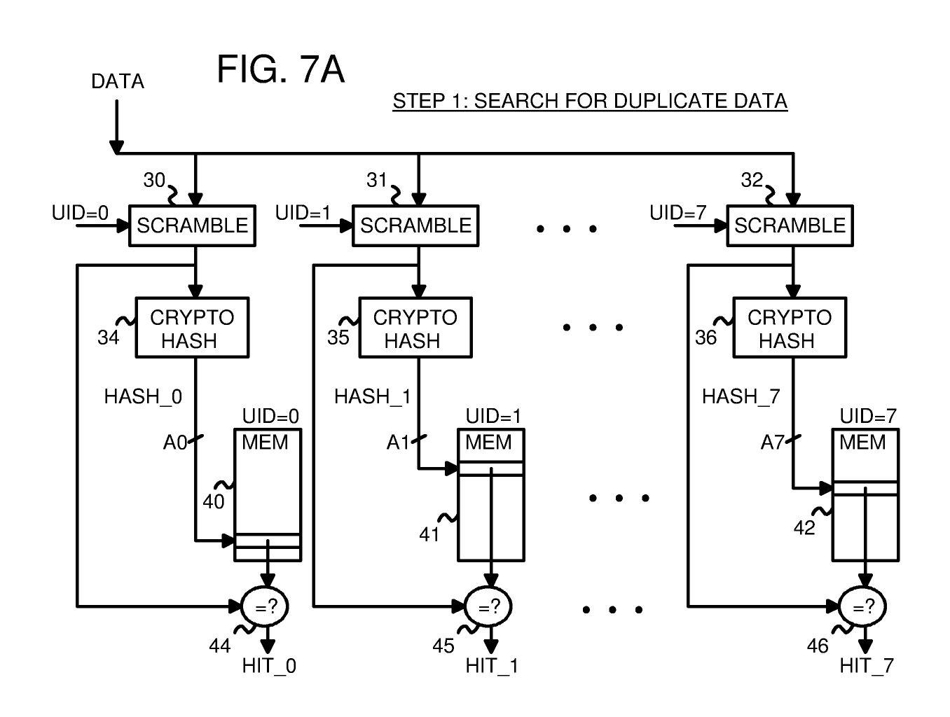

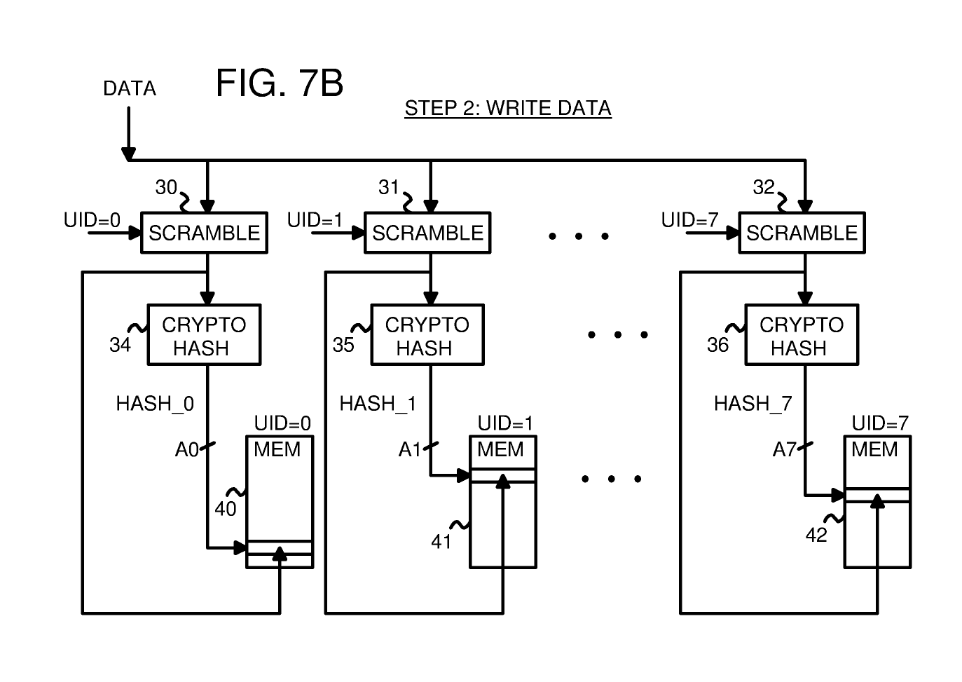

FIGS. 7A, 7B highlight error detection for a data de-duplication storage system with storage location randomization across replication nodes. In FIG. 7A, the data is scrambled by scrambler 30, 31, . . . 32 and hashed by cryptohash engine 34, 35, . . . 36 to generate the hashes that are applied as addresses to memory 40, 41, . . . 42. However, a read of memory 40, 41, . . . 42 is first performed, and comparators 44, 45, . . . 46 compare the new scrambled data from scrambler 30, 31, . . . 32 to the data read out of memory 40, 41, . . . 42 for each replication node. When the old and new scrambled data match for that node, a hit is signaled.

When all of comparators 44, 45, . . . 46 signal a hit, there is no collision due to aliasing of the hashes. When all of comparators 44, 45, . . . 46 signal a miss, such as when there was no old data stored in this location, the new scrambled data from scrambler 30, 31, . . . 32 can be written to that location addressed by the hash, as shown in FIG. 7B.

When one or more of comparators 44, 45, . . . 46 signals a miss, a collision or other data loss has occurred. An error handling routine can be activated. Data from replication nodes that hit can be used while replication nodes that signaled a miss can be over-written with the new data, as shown in FIG. 7B.

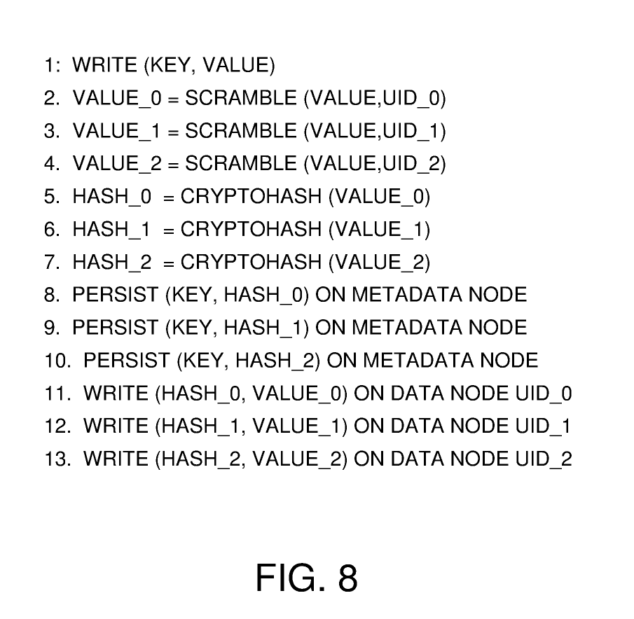

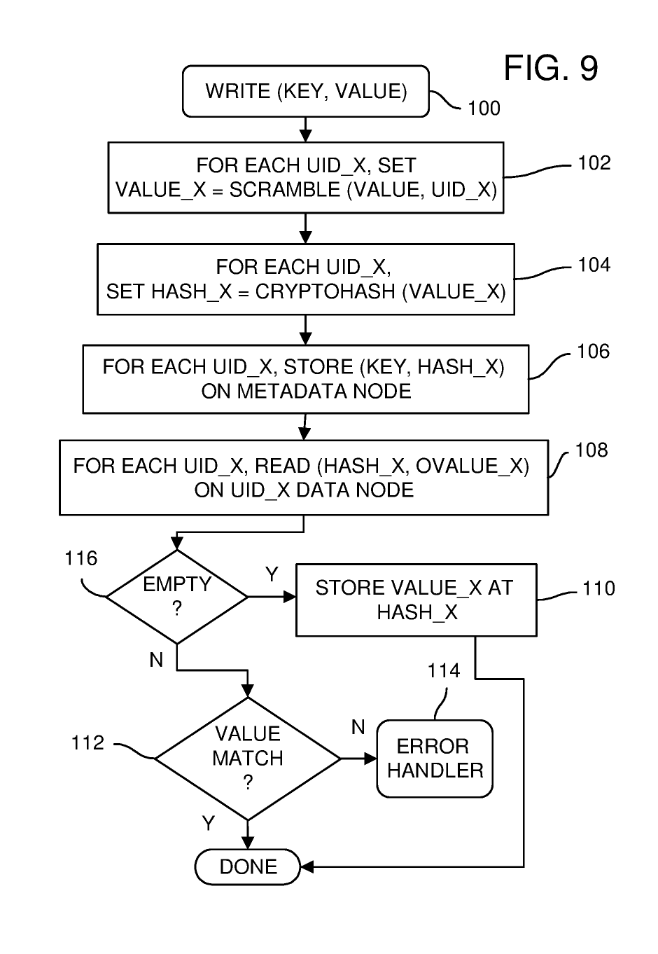

FIG. 8 shows pseudo-code that pre-scrambles data before hashing to perform data de-duplication with replication. In line 1, user data VALUE is written to a location identified by the KEY. The key could be a file name and path, a keyword, a Logical Block Address (LBA), system address, or some other identifier.

In line 2, the data VALUE is scrambled using the unique identifier for the first replication node, UID_0, as the seed. The scrambled data is VALUE_0. In line 3, the input data VALUE is scrambled, but using the unique identifier for the second replication node, UID_1, as the seed. The scrambled data is VALUE_1, which is not the same as VALUE_0. In line 3, the input data VALUE is scrambled, but using the unique identifier for the third replication node, UID_2, as the seed. The scrambled data is VALUE_2. Each replication node has its own unique scrambled data, VALUE_0, VALUE_1, or VALUE_2.

In lines 5-7, these scrambled data are cryptographically hashed to produce three unique hashes, one for each replication node. For example, in line 6, scrambled data VALUE_1 for the second replication node is hashed to generate HASH_1.

In lines 8-10, the key, hash pairs are stored as one or more entries in metadata storage 50. One entry could be used with all 3 hashes, such as KEY, HASH_0, HASH_1, HASH_2, or 3 separate or linked entries could be stored.

In lines 11-13, the user data is written to the replication data nodes. In line 11, the hash for the first replication node, HASH_0, is used as the address where the scrambled data VALUE_0 is stored to in the first replication node, UID_0. In line 12, the hash for the second replication node, HASH_1, is used as the address where the scrambled data VALUE_1 is stored to in the first replication node, UID_{—} 1. In line 13, the hash for the third replication node, HASH_2, is used as the address where the scrambled data VALUE_2 is stored to in the first replication node, UID_2. Note that the scrambled data (VALUE_0, VALUE_1, VALUE_2) stored is different for all three replication nodes.

FIG. 9 is a flowchart of writing to replicated data nodes using hashes of uniquely scrambled data. The system sends the write command with the key and the user data VALUE, step 100. Each replication node X has a unique identifier, UID_X, which is applied as the seed into to the scrambler to generate scrambled data VALUE_X from VALUE, step 102. The scrambled data is hashed in step 104 to generate the hash HASH_X for each replication node. Thus each replication node has its own scrambled data and hash generated in steps 102, 104. These hashes are stored with the key in the metadata storage node, step 106.

On each replication node UID_X, the old data OVALUE_X that is stored at the address of HASH_X is read, step 108. When no old data was previously stored for this hash, step 116, the data is empty, and the new scrambled data VALUE_X is written at this address HASH_X, for each of the replication nodes, step 110.

When the old data was present in the entry at address HASH_X, step 116, then the old scrambled data OVALUE_X is compared to the new data VALUE_X, step 112. When the old and new scrambled data values match, the write completes successfully. When the old and new scrambled data values mis-match, step 112, then some sort of error has occurred, Error handler 114 is activated. Error handler 114 can compare old and new scrambled data for all replication nodes, and over-write the old scrambled data with the new scrambled data for that node, VALUE_X, in one or more nodes that mismatch. The physical memory location when the mis-match occurred may be marked as faulty and removed from further use.

Error handler 114 may also perform anti-aliasing functions if a collision had occurred. The probability of a collision occurring is very low using cryptographic hashes, but if a collision does occur, it is very unlikely that a collision would occur for all X different hashes HASH_X, since each replication node has a different hash and different scrambled data that is stored.

With a strong crypto hash, the probability of a collision, C, is so low that that if two data blocks hash to the same hash value, they are assumed to be the same data. The probability of a collision occurring on all X nodes is C^{X}, which is much less probable that for a single node. Thus a collision in one replication node, although unlikely, is easily recovered from by using the other replication nodes having different hash values. Error handler 114 may thus be simplified or eliminated. Steps 116, 112, 114 may be deleted and step 108 always flows directly to step 110.

As an alternative, rather than read the old data, a search for all corresponding hashes in metadata storage 50 could be performed. When all searches fail, no matching hash was found, so no old data was previously stored. Then the new scrambled data VALUE_X can be stored into the user nodes, and a new hash entry stored in the metadata storage. An anti-aliasing function may be activated when some but not all hash searches succeed.

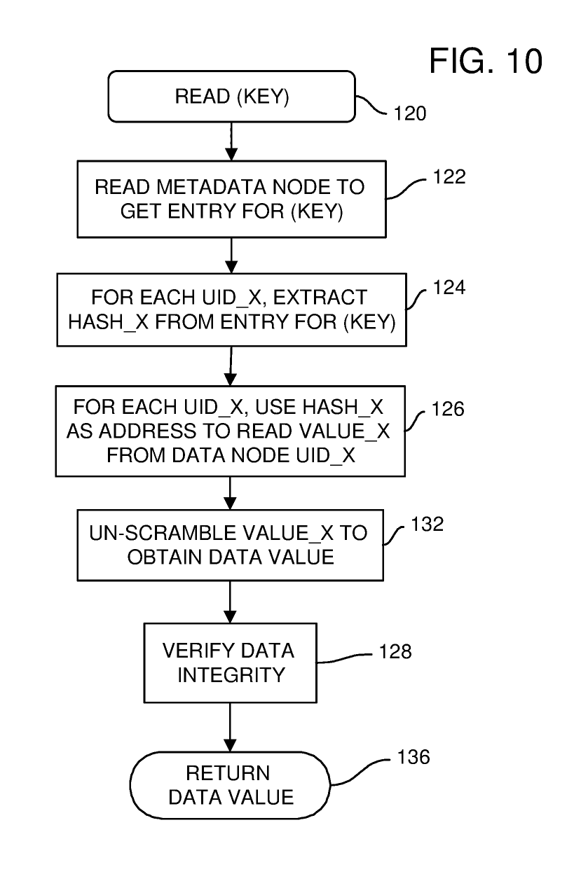

FIG. 10 is a flowchart of reading from replicated data nodes using hashes of uniquely scrambled data. The system sends the read command with the key, step 120. The KEY is looked up in the metadata storage to find a matching entry, step 122. The hashes are read from this matching entry, step 124. One hash HASH_X is read for each of the replication nodes UID_X.

The hash read from metadata storage, HASH_X, is applied to a replication node UID_X as the address to read the stored data, VALUE_X, step 126. Each replication node has a different hash read from the matching entry in metadata storage, and each maps to a different physical location or offset within a replication node. A total of X scrambled data values VALUE_X are read. These are scrambled data, so the stored data for each node is unscrambled, step 132, to obtain the data value VALUE.

Although each replication node stored a different scrambled data VALUE_X, all stored scrambled data should return the same un-scrambled data VALUE. The unscrambled data from each of the X replication nodes is compared to verify data integrity, step 128. If one replication node's unscrambled data does not match the data from the other nodes, it is likely that the one mis-matching node is in error, while the majority of replication nodes that return the same unscrambled data value are correct. The unscrambled data value obtained by the majority of the replication nodes is returned to the system as the data VALUE, step 136, as the read operation completes. Meanwhile, for each mismatching node X, unscrambled data from the majority of the replication nodes is scrambled again with UID_X and the hash re-applied. The new HASH_X is written into the metadata, and the re-generated data is sent to node X to overwrite the original data.

### Alternate Embodiments

Several other embodiments are contemplated by the inventor. For example many partitionings or arrangements of functions, operations, routines, procedures, memories, devices, controllers, and structures are possible. Metadata storage 10 and memory 40, 41, . . . 42 could be multiple nodes of mass-storage, and may contain faster cache memory and buffers, or they may be implemented on a single storage node with multiple drives, where data is replicated to multiple drives. The procedures described, such as for FIGS. 9, 10, could be implemented as hardware controllers, or firmware that executes on a processor or a general-purpose computer, with the replication nodes each being a mass-storage device that is connected to the computer by an I/O bus or connector. The metadata storage could also be a mass-storage device, or could be a solid-state memory such as flash or a dynamic-random-access memory (DRAM), Storage Class Memory, or various combinations.

While the unique identifier could be applied directly to cryptohash engine 34, 35, . . . 36, such as by addition, this might change the hash uniform distribution properties, effectively weakening the security of the strong hash, and causing distribution imbalances. Thus the inventor prefers to scramble the data first before hashing, so that the hashing function is not altered between replication nodes. Pre-scrambling is thought to provide a more robust system than if scrambling was combined with hashing.

Collisions are much less likely to occur when stronger hashes are used. Some systems could avoid comparing the previously stored data to the write data, as well as using anti-aliasing routines, and instead that if the hashes match, the stored data also mates. This assumes that the likelihood of a collision is so small that it is near zero. However, if a collision did occur, having different hashes in each replication node would reduce the chances of data loss, since all hashes for all replication nodes would have to collide, which is even less likely. Finally, the different scrambled data stored in each replication node provide a way to recover from a collision in one of the replication nodes, since the correct data would still be available from the other replication nodes.

Other data could be stored with the entry in metadata storage 50, such as valid bits. A garbage collection routine could be performed to removed outdated entries. For frequently-used data, there may be many keys that map to the same data storage location. There may be multiple key, hash entries placed in metadata storage 50, with the key being different for each entry, but the hashes being the same for all entries. Alternately, the entries could contain the key and a pointer to the list of hashes.

For append-only systems, such as flash memory systems that store blocks in a time sequence, PNG 54, 55, 56 can be replaced with a Linear-Feedback-Shift Register (LFSR), with the unique identifier being applied to a seed input that initializes the LFSR sequence, or determines the starting location within the LFSR sequence. A LBA from metadata storage 10 is not needed for an append-only system. The LFSR or PNG sequences can be modulo the number of storage locations in a replication node.

Memories 40, 41, 42 can be hard disk drives, flash drives, Storage Class Memory (SCM), DRAM, or other mass storage media, and can have auxiliary memory such as DRAM, NVRAM, or SRAM cache and buffers. Volatile or non-volatile memory may be used. The mass-storage memory can be arranged as a block-based memory, a distributed file system, or as object storage. The replication nodes could be distributed object clusters.

While homogenous replication nodes are shown, the replication nodes could differ and do not have to be identical. When 3 replication nodes and 8 replication nodes have been shown, other numbers of replication nodes can be substituted. The number of replication nodes can change during a systems lifetime, as replication nodes are installed and removed, such as during system maintenance. The replication nodes could be co-located, or some could be at different geographic locations.

Cluster management system 52 may assign unique identifiers to replication nodes in a sequence such as an ascending sequence as shown, or in some other sequence or procedure. The unique identifier could come from the hardware of the replication node itself, with cluster management system 52 ensuring that no two replication nodes have the same unique identifier. Cluster management system 52 could also modify an identifier supplied by each replication node.

The invention could also be applied to an embedded form factor where each replication node is a bank or other division of a large memory array. While metadata storage 50 may be maintained by software, firmware or hardware controllers could also be used. Content-addressable memories (CAM) may be used. Various sub-tables and linked tables or linked entries may be used in metadata storage 50. Many formats of entries are possible.

Scrambler 30, 31, . . . 32 may use various deterministic scrambling functions, such as swapping bit positions, randomizing, additive and multiplicative scrambling. However, scrambler 30, 31, . . . 32 are not purely random but are deterministic, and reversible so that the unscrambled data can be recovered from the scrambled data. The unique identifier can seed or initialize scrambler 30, 31, . . . 32 in a variety of ways, such as first using the unique identifier as an input to a LFSR register to get a unique number, then using a generated number and a data payload as an input stream to an additive and multiplicative scrambler.

Scrambler 70 and cryptohash engine 74 could operate serially, applying a different node's unique identifier and then generating that node's scrambled data and hash, before changing the unique identifier and generating the hash for the next replication node. Alternately, scrambler 70 and cryptohash engine 74 could have parallel data paths, so that all 8 hashes could be generated at the same time. Scrambler 70 and cryptohash engine 74 could be pipelined, with cryptohash engine 74 generating the hash for the prior node while scrambler 70 is scrambling data for the next node. The scrambled data from scrambler 70 could be stored for each node and later written to each of the replication nodes when different scrambled data is stored in each replication node, or the same scrambled data or unscrambled data is stored in each replication node. Scrambler 70 and cryptohash engine 74 could also be shared for a few but not all replication nodes.

Cryptohash engine 34, 35, . . . 36 uses a strong hash, such as a cryptographic-quality hash, such as SHA2, SHA3, BLAKE, etc. Using a strong hash results in a lower chance of collisions, so that it is extremely unlikely that two data values will map to the same hash value. For example, the SHA2 hash can have up to 512 bits. Alternatively, a weaker non-crypto hash (SHA-1, MD5) may be used with the use of an anti-aliasing mechanism to handle hash collisions.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A data de-duplicating storage system comprising:
a plurality of replication nodes, each replication node storing only one copy of a data value, each replication node in the plurality of replication nodes having a plurality of storage locations that are addressed by an address input;
a cluster management system that assigns a unique identifier to each replication node in the plurality of replication nodes, wherein each replication node has a different value of the unique identifier;
a data scrambler that receives the unique identifier for a target replication node in the plurality of replication nodes, the unique identifier seeding the data scrambler to generate scrambled data from a data input receiving a data input value, wherein the data scrambler receives a different value of the unique identifier for each target replication node in the plurality of replication nodes, to generate a different value of the scrambled data from the data input value of the data input for each replication node in the plurality of replication nodes; and
a hash engine that receives the scrambled data from the data scrambler, and generates a hash of the scrambled data;
wherein the hash engine generates a different value of the hash for each replication node in the plurality of replication nodes;
wherein the hash engine receives a different value of the scrambled data for each target replication node in the plurality of replication nodes, to generate a different value of the hash from the scrambled data for each replication node in the plurality of replication nodes;
wherein the hash from the hash engine that is generated for the target replication node is applied to the address input of the target replication node for each target replication node in the plurality of replication nodes, wherein a different value of the hash is applied to the address input for each replication node in the plurality of replication nodes;
whereby data is stored to different storage locations in the plurality of replication nodes.

2. The data de-duplicating storage system of claim 1 wherein the plurality of replication nodes comprises at least three target replication nodes.

3. The data de-duplicating storage system of claim 2 wherein the scrambled data generated by the data scrambler using the unique identifier for a target replication node in the plurality of replication nodes is written to a storage location addressed by the hash of the scrambled data, for each target replication node in the plurality of replication nodes,
whereby different values of scrambled data are stored in the plurality of replication nodes at different address locations.

4. The data de-duplicating storage system of claim 3 further comprising:
a metadata storage node for storing metadata, the metadata associating a key with a plurality of hashes;
wherein the plurality of hashes comprises the hash generated by the hash engine in response to the data input value applied to the data scrambler for the target replication node, for all target replication nodes in the plurality of replication nodes;
wherein a hash is stored in the metadata storage node with the key for all target replication nodes in the plurality of replication nodes.

5. The data de-duplicating storage system of claim 4 wherein the metadata includes a plurality of entries, each entry having a key received from a system generating the data input value and the key, each entry including the plurality of hashes;
wherein a key is associated with a plurality of hashes.

6. The data de-duplicating storage system of claim 5 wherein the key is a logical block address from the system generating the data input value and the key.

7. The data de-duplicating storage system of claim 5 wherein the key is a filename and path from the system generating the data input value and the key.

8. The data de-duplicating storage system of claim 5 wherein the key is a object name from the system generating the data input value and the key.

9. The data de-duplicating storage system of claim 3 further comprising:
a data unscrambler that receives the unique identifier for the target replication node in the plurality of replication nodes, the unique identifier seeding the data unscrambler to generate unscrambled data in response to a data input receiving the scrambled data read from the target replication node, wherein the data unscrambler receives a different value of the unique identifier for each target replication node in the plurality of replication nodes;
wherein the data unscrambler receives a different value of the scrambled data for each replication node in the plurality of replication nodes;
wherein the data unscrambler generates a same value of the unscrambled data for all target replication nodes in the plurality of replication nodes when no error occurs.

10. The data de-duplicating storage system of claim 9 further comprising:
a comparator that compares the unscrambled data generated by the data unscrambler for all target replication nodes in the plurality of replication nodes and signals an error when a mismatch of the unscrambled data occurs.

11. The data de-duplicating storage system of claim 10 further comprising:
an error recovery controller, activated when the error is signaled by the comparator, for returning the unscrambled data for a majority of the target replication nodes in the plurality of replication nodes when the error is signaled.

12. A data de-duplicating replica storage system comprising:
a plurality of replication nodes for storing replicas of data;
a cluster management system that assigns a unique identifier to each replication node in the plurality of replication nodes, wherein each replication node has a different value of the unique identifier;
a request input from a host system, the request input receiving write data;
each replication node in the plurality of replication nodes comprising:
a data storage device having a plurality of storage locations that are addressed by an address input;
a data scrambler that receives the write data and receives the unique identifier for a replication node, the unique identifier seeding the data scrambler to generate scrambled data from the write data,
a hash engine that receives the scrambled data from the data scrambler, and generates a hash of the scrambled data;
wherein the hash generated by the hash engine is applied to the address input of the data storage device to select a physical location to store data within the data storage device;
whereby write data is scrambled then hashed to address the data storage device.

13. The data de-duplicating replica storage system of claim 12 wherein the scrambled data generated by the data scrambler is applied to a write data input of the data storage device;
wherein the scrambled data is stored in the data storage device;
wherein each replication node stores a different value of the scrambled data into the data storage device of that replication node;
whereby different scrambled data generated from the write data is stored in each replication node, at different relative physical locations within the data storage device of each replication node,
whereby both data and storage locations are scrambled.

14. The data de-duplicating replica storage system of claim 13 wherein each replication node stores only one copy of a data value,
whereby data is de-duplicated in each replication node.

15. The data de-duplicating replica storage system of claim 12 further comprising:
a request input from a host system, the request input receiving write data and a key, wherein the key is used by the host system to later retrieving the write data.

16. The data de-duplicating replica storage system of claim 15 further comprising:
a metadata storage node for storing metadata including an address map that maps the key from the request input to a plurality of hashes generated by the hash engine for the plurality of replication nodes,
wherein each key is mapped to a plurality of hashes.

17. The data de-duplicating replica storage system of claim 12 wherein the data storage device in the plurality of replication nodes has a same specified storage capacity and are manufactured by a same manufacturer for all replication nodes,
whereby replication nodes are homogenous.

18. A location-randomizing data de-duplicator comprising:
a host interface for receiving write data and a key from a host;
a metadata storage node for storing metadata that associates the key with a plurality of hashes;
a plurality of replication nodes for storing user data, each replication node being uniquely identified by a unique identifier;
a scrambler that scrambles the write data to generate scrambled data, the scrambler also receiving the unique identifier, the unique identifier adjusting a deterministic scramble function performed by the scrambler so that the write data scrambled using different values of the unique identifier generate different values of the scrambled data from a same value of the write data;
a hasher that receives the scrambled data from the scrambler and generates a hash;
wherein each unique identifier for the plurality of replication nodes is applied to the scrambler to generate a plurality of different values of the scrambled data that are applied to the hasher to generate the plurality of hashes having different values;
wherein the plurality of hashes are written to the metadata storage node and associated with the key received from the host along with the write data used to generate the plurality of hashes;
each replication node in the plurality of replication nodes having a data storage device that receives a hash in the plurality of hashes generated by the hasher, wherein a hash generated using a unique identifier that identifies a particular replication node is applied to an address input of the data storage device of that particular replication node;
wherein write data is stored to different address locations in the data storage devices of the plurality of replication nodes.

19. The location-randomizing data de-duplicator of claim 18 further comprising:
applying the scrambled data generated using the unique identifier for a particular replication node to a write data input of the data storage device of that particular replication node to store the scrambled data to a location determined by the hash generated for that particular replication node;
wherein different scrambled data is stored for each replication node, and to different physical locations in each replication node.

20. The location-randomizing data de-duplicator of claim 19 wherein the data storage devices are hard disk drives, storage class memory (SCM), or flash memory, and
wherein the plurality of replication nodes comprises at least 3 replication nodes.
